(19) United States
(12) Patent Application Publication
(10) Pub. No.: US 2015/0358844 A1
(43) Pub. Date: Dec. 10, 2015

(54) WIRELESS COMMUNICATION METHOD FOR DETERMINING WHETHER TO DETECT RADIO SIGNAL, AND WIRELESS COMMUNICATION SYSTEM AND WIRELESS COMMUNICATION APPARATUS THEREOF

(71) Applicant: FUJITSU LIMITED, Kawasaki-shi (JP)

(72) Inventors: Yun WEN, Kawasaki (JP); Makoto YOSHIDA, Yokohama (JP); Hiroshi FUJITA, Yokosuka (JP)

(73) Assignee: FUJITSU LIMITED, Kawasaki-shi (JP)

(21) Appl. No.: 14/832,391

(22) Filed: Aug. 21, 2015

Related U.S. Application Data
(62) Division of application No. 13/424,852, filed on Mar. 20, 2012.

(30) Foreign Application Priority Data
Mar. 31, 2011 (JP) 2011-079353

(51) Int. Cl. H04W 24/08; H04W 40/08; H04B 7/26

(52) U.S. Cl. CPC H04W 24/08; H04B 7/2606; H04W 40/08; H04W 88/02

(57) ABSTRACT

A wireless communication method includes starting, at a first wireless communication apparatus and a second wireless communication apparatus respectively, transmission of a wireless signal, when received power of a wireless signal transmitted from another wireless communication apparatus is smaller than or equal to a carrier sense threshold value, transmitting, from the first wireless communication apparatus, a wireless signal, and determining, at the second wireless communication apparatus, whether or not to receive a data signal following a first signal included in the wireless signal received from the first wireless communication apparatus, based on at least one of received power of the first signal and a transmission destination included in the wireless signal.

### CROSS-REFERENCE TO RELATED APPLICATION

This is a divisional application of U.S. patent application Ser. No. 13/424,852, filed on Mar. 20, 2012, which is based upon and claims the benefit of priority of the prior Japanese Patent Application No. 2011-079353, filed on Mar. 31, 2011, the entire contents of which are incorporated herein by reference.

### FIELD

The embodiments discussed herein are related to a wireless communication method, a wireless communication system, and a wireless communication apparatus.

### BACKGROUND

Currently, wireless communication systems such as a mobile phone system and a wireless local area network (LAN) are widely used. In the field of wireless communication, the next generation communication technology is continuously discussed to further improve communication speed and communication capacity.

On the other hand, there is a so-called wireless ad hoc network as one of the wireless communication systems. The wireless ad hoc network system is, for example, a wireless communication system in which a wireless communication apparatus (hereinafter referred to as “wireless station”) autonomously performs wireless communication without using infrastructure facilities such as a wireless base station. An example of the wireless ad hoc network system is a network system in which wireless stations are mounted on fire engines and police cars and the fire engines and the police cars may wirelessly communicate with each other via the wireless stations.

### SUMMARY

According to an aspect of the invention, a wireless communication method includes starting, at a first wireless communication apparatus and a second wireless communication apparatus respectively, transmission of a wireless signal, when received power of a wireless signal transmitted from another wireless communication apparatus is smaller than or equal to a carrier sense threshold value, transmitting, from the first wireless communication apparatus, a wireless signal, and determining, at the second wireless communication apparatus, whether or not to receive a data signal following a first signal included in the wireless signal received from the first wireless communication apparatus, based on at least one of received power of the first signal and a transmission destination included in the wireless signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a wireless communication apparatus by a minimum hop count method;

FIG. 2A is a diagram illustrating a configuration of a wireless communication apparatus by a hop quality oriented method; and

FIG. 2B is a diagram illustrating a received power of data.

FIG. 3 is a diagram illustrating a configuration of a wireless communication system of a first embodiment;

FIG. 4 is a diagram illustrating a configuration of a wireless communication system of a second embodiment;

FIG. 5 is a diagram illustrating a communication range of a wireless communication system;

FIG. 6 is a diagram illustrating a configuration of a wireless communication apparatus;

FIG. 7A is a diagram illustrating a path information packet;

FIG. 7B is a diagram illustrating a path information table of a wireless station;

FIG. 7C is a diagram illustrating a wireless signal or a reception signal;

FIG. 8 is a flowchart illustrating a path information registration process;

FIG. 9 is a diagram illustrating a reception determination threshold value determination process;

FIG. 10 is a diagram illustrating a reception determination process;

FIG. 11A is a diagram illustrating a communication range between wireless stations;

FIG. 11B is a diagram illustrating a transmission timing;

FIG. 11C is a diagram illustrating a received power of data;

FIG. 12 is a sequence diagram illustrating an operation in a wireless communication system;

FIG. 13A is a diagram for explaining the minimum number of transmission times in a wireless communication system;

FIG. 13B is a diagram for explaining the minimum number of transmission times in the wireless communication system;

FIG. 14 is a diagram illustrating a configuration of a wireless communication apparatus;

FIG. 15 is a flowchart illustrating a reception determination process;

FIG. 16 is a diagram illustrating a configuration of a wireless communication apparatus;

### DESCRIPTION OF EMBODIMENTS

Hereinafter, embodiments of the present disclosure will be described.

While inventing the present embodiments, observations were made regarding a related art. Such observations include the following, for example.

In a wireless ad hoc network system, a wireless station may transmit a wireless signal by performing a carrier sense before transmitting the wireless signal. For example, when the wireless station does not detect received power that is larger than or equal to a carrier sense threshold value in a received wireless signal, the wireless station may start transmission to another wireless station by determining that a channel is in an idle state. On the other hand, when the wireless station detects received power that is larger than or equal to the carrier sense threshold value in a received wireless signal, the wireless station does not transmit a wireless signal to another wireless station by determining that a channel is in a busy state. Regarding reception, when the wireless station detects a preamble signal transmitted from another wireless station, the wireless station may start reception of a data signal (hereinafter referred to as “data”) transmitted from the other wireless station.

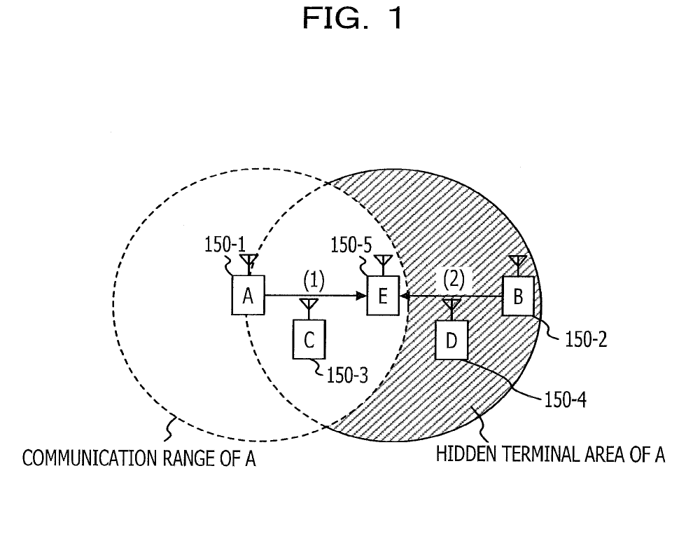

However, there is a problem so-called “hidden terminal problem” in the wireless ad hoc network system. FIG. 1 is a diagram for explaining the “hidden terminal problem”. In FIG. 1, there are five wireless stations (A) 150-1 to (E) 150-5, and the wireless station (B) 150-2 is located outside a communication range of the wireless station (A) 150-1.

For example, the wireless station (B) 150-2 is located outside the communication range of the wireless station (A) 150-1, so that the wireless station (A) 150-1 does not receive a wireless signal from the wireless station (B) 150-2 (or the wireless station (A) 150-1 detects that the wireless signal is smaller than or equal to the carrier sense threshold value). The wireless station (A) 150-1 may transmit a wireless signal to the wireless station (E) 150-5 by using a certain radio frequency (or radio frequency band, hereinafter referred to as “radio frequency”) at a certain timing.

On the other hand, the wireless station (B) 150-2 does not receive a wireless signal transmitted from the wireless station (A) 150-1 (or the wireless station (B) 150-2 detects that the wireless signal is smaller than or equal to the carrier sense threshold value). Therefore, the wireless station (B) 150-2 may transmit a wireless signal to the wireless station (E) 150-5 by using the same radio frequency as that of the wireless station (A) 150-1 at the same timing.

The two wireless signals transmitted from the wireless station (A) 150-1 and the wireless station (B) 150-2 by using the same radio frequency at the same timing collide with each other at the wireless station (E) 150-5. In this case, one wireless signal becomes an interference signal to the other wireless signal, so that the wireless station (E) 150-5 may receive none of the wireless signals.

When a transmission wireless station transmits a wireless signal to a reception wireless station, a wireless station which is located within a communication range of the reception wireless station and which does not carrier-sense the transmission of the transmission wireless station becomes a hidden wireless station (hereinafter referred to as “hidden terminal”). A wireless station which is located within a communication range of the reception wireless station and at which received power from the transmission wireless station is smaller than or equal to the carrier sense threshold value also becomes a hidden terminal. The hidden terminal problem is a situation in which such a hidden terminal occurs. In FIG. 1, the wireless station (D) 150-4 and the wireless station (B) 150-2 are hidden terminals for the wireless station (A) 150-1.

On the other hand, in the wireless ad hoc network system, multi-hop communication may be performed. The multi-hop communication is a communication method in which, when a transmission source wireless station and a destination wireless station do not perform direct wireless communication with each other, the wireless communication is performed using relay by other wireless stations.

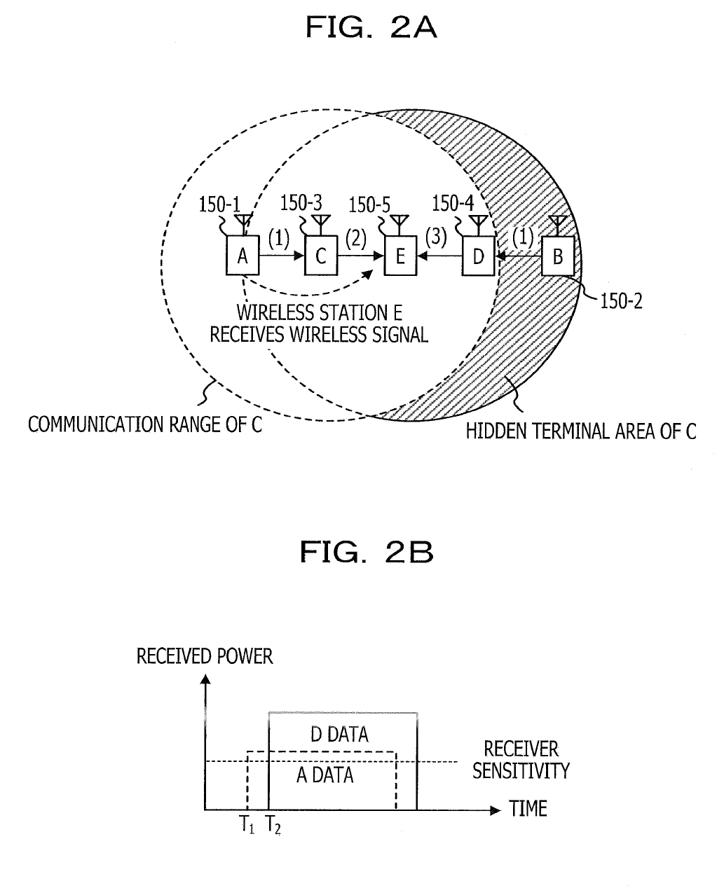

In the multi-hop communication, there are two methods, which are a minimum hop count method and a hop quality oriented method. FIG. 1 illustrates a wireless communication by the minimum hop count method. FIG. 2A illustrates a wireless communication by the hop quality oriented method.

The wireless communication by the minimum hop count method is a method in which, for example, the number of transmission times (or the hop count) to the destination is set to minimum to select a path having a smallest hop count and wireless communication is performed. In FIG. 1, although a path from the wireless station (A) 150-1 to the wireless station (E) 150-5 may be a path through the wireless station (C) 150-3, in this case, the hop count is 2. On the other hand, the destination wireless station (E) 150-5 is located within a communication range of the wireless station (A) 150-1, so that the hop count may be 1. Therefore, the wireless station (A) 150-1 selects this path. The wireless station (B) 150-2 also selects a path directly connected to the wireless station (E) 150-5. In this way, in the minimum hop count method, a wireless station may obtain a smallest hop count to the destination wireless station by performing wireless communication with another wireless station located at a maximum communication distance or the like.

On the other hand, the hop quality oriented method is a method in which reception quality of wireless signal in a reception wireless station is taken into account and wireless communication is performed between a transmission wireless station and a reception wireless station, the distance between which is less than a certain distance. In FIG. 2A, the wireless station (A) 150-1 selects the wireless station (C) 150-3, which is located within a certain distance range, as a transmission destination, and the wireless station (C) 150-3 selects the wireless station (E) 150-5, which is located within a certain distance range, as a transmission destination. Similarly, the wireless station (B) 150-2 may transmit a wireless signal to the wireless station (E) 150-5 by using the wireless station (D) 150-4 as a relay station.

When comparing the minimum hop count method and the hop quality oriented method, a distance between wireless stations in the hop quality oriented method is shorter than that in the minimum hop count method, so that the number of hidden terminals in the hop quality oriented method may be smaller than that in the minimum hop count method. For example, in FIG. 2A, wireless station (C) 150-3, which is a destination of wireless signal, may receive a wireless signal transmitted from the wireless station (C) 150-3. Therefore, the communication range of the wireless station (C) 150-3, which may transmit a wireless signal to the wireless station (E) 150-5, is a communication range corresponding to the hidden terminal problem. When comparing with that in FIG. 1 which is an example of the minimum hop count method, the range corresponding to the hidden terminal problem in the hop quality oriented method (shaded area in FIG. 2A) is smaller than that in the minimum hop count method (shaded area in FIG. 1). The wireless station (D) 150-4, which is a hidden terminal in the minimum hop count method, is not a hidden terminal in the hop quality oriented method. In this way, in the hop quality oriented method, the number of hidden terminals is smaller than that in the minimum hop count method, so that it is possible to reduce the probability of collision of wireless signals in a destination wireless station.

Further, in the hop quality oriented method, the probability, in which the destination wireless station does not receive a wireless signal from a certain wireless station when the wireless signal collides with a wireless signal from a hidden terminal, may be smaller than that in the minimum hop count method. For example, in FIG. 2A, the distance between the wireless station (E) 150-5 and the wireless station (C) 150-3 is shorter than the distance between the wireless station (E) 150-5 and the wireless station (B) 150-2. Therefore, in the wireless station (E) 150-5, even when a wireless signal transmitted from the wireless station (C) 150-3 collides with a wireless signal from the wireless station (B) 150-2, a signal to interference ratio (herein after referred to as SIR) of the wireless signal transmitted from the wireless station (C) 150-3 is higher than that of the wireless signal that is directly received from the wireless station (B) 150-2. Therefore, even when two wireless signals are transmitted using the same radio frequency at the same timing, in the wireless station (E) 150-5, the probability of successful reception of the wireless signal transmitted from the wireless station (C) 150-3 is higher than that of the wireless signal transmitted from the wireless station (B) 150-2.

There are techniques described below that are related to the wireless communication system described above. For example, a second wireless station adds interference power information and received power information for control information received from a first wireless station to an RTS (Request to Send)/CTS (Clear to Send) packet and transmits the RTS/CTS packet. Then, a third wireless station determines whether or not a packet may be simultaneously transmitted to the second wireless station based on the interference power information and the received power information included in the packet, so that the transmission capacity of the entire system is improved.

Further, there is a carrier sense device which synthesizes reception signals received through a plurality of antennas, calculates a reception level from the synthesized reception signal, and determines the state of use of a channel by comparing the calculated reception level with a threshold value.

Japanese Laid-open Patent Publication No. 2007-166373 and Japanese Laid-open Patent Publication No. 2010-81128 are examples of related art.

Although, as described above, in the hop quality oriented method, the number of hidden terminals may be smaller than that in the minimum hop count method, the number of transmission times is greater than that in the minimum hop count method because a wireless signal is transmitted to a destination wireless station by relay between wireless stations within a communication range.

For example, in FIG. 2A, it is assumed that the wireless station (A) 150-1 transmits a wireless signal earlier than the wireless station (D) 150-4. FIG. 2B is a diagram illustrating a relationship between received power and time of wireless signals transmitted from the two wireless stations (A) 150-1 and (D) 150-4 at the wireless station (E) 150-5. In this case, the wireless station (E) 150-5 is located within a communication range of the wireless station (A) 150-1, so that a wireless signal transmitted from the wireless station (A) 150-1 to the wireless station (C) 150-3 may be directly received by the wireless station (E) 150-5. The wireless station (E) 150-5 first receives the wireless signal from the wireless station (A) 150-1, so that the wireless station (E) 150-5 does not receive the wireless signal transmitted thereafter from the wireless station (D) 150-4. In this case, for example, the wireless station (D) 150-4 re-transmits the wireless signal.

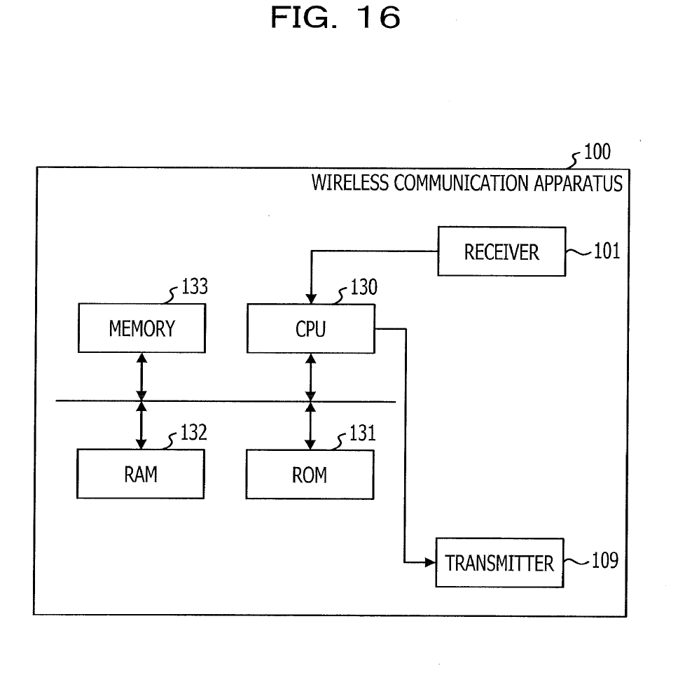

In this situation, the smallest number of transmission times is three for the wireless signals that are transmitted from the two wireless stations (A) 150-1 and (B) 150-2 to the wireless station (E) 150-5. Specifically, the wireless station (A) 150-1 and the wireless station (B) 150-2 respectively transmit wireless signals to the wireless station (C) 150-3 and the wireless station (D) 150-4 by using the same radio frequency at the same timing, so that the number of transmission times becomes minimum. In this case, the two wireless stations (A) 150-1 and (B) 150-2 are located within a communication range of the wireless station (E) 150-5, so that the two wireless signals may be directly transmitted to the wireless station (E) 150-5. However, in the wireless station (E) 150-5, one of the two wireless signals becomes an interference signal to the other wireless signal, so that both signals are not received. The two wireless stations (C) 150-3 and (D) 150-4 respectively wait for completion of the transmissions of the wireless signals transmitted from the wireless stations (A) 150-1 and (B) 150-2, and then respectively transmit the received wireless signals to the wireless station (E) 150-5. However, the two wireless signals are not received by the wireless station (E) 150-5 at the same timing, so that the two wireless stations (C) 150-3 and (D) 150-4 transmit the wireless signals at timings different from each other. Thereby, the minimum number of transmission times is three in the hop quality oriented method illustrated in FIGS. 2A and 2B. In FIGS. 2A and 16B, the transmissions of the three times respectively correspond to (1) to (3).

On the other hand, in FIG. 1, which illustrates a minimum hop count method, if the two wireless stations (A) 150-1 and (B) 150-2 transmit wireless signals by using the same radio frequency at the same timing, the wireless signals are not received by the wireless station (E) 150-5. Therefore, the two wireless stations (A) 150-1 and (B) 150-2 transmit wireless signals at timings different from each other, so that the minimum transmission times is two. In FIG. 1, the transmissions of the two times respectively correspond to (1) and (2).

In this way, in the hop quality oriented method, the number of transmission times is greater than that in the minimum hop count method, so that it takes a long time for a wireless signal to reach the destination wireless station. Therefore, in the hop quality oriented method, the network capacity in the entire wireless communication system may be smaller than that in the minimum hop count method.

In the above-described technique for adding interference power information and received power information for received control information to an RTS/CTS packet, there is a case in which wireless signals are not transmitted from two wireless stations at the same time, so that it is difficult to solve the problem of reduction in the network capacity. Also, in the above-described technique for determining the state of use of a channel, only the state of use of a channel is determined, so that it is difficult to solve the problem of reduction in the network capacity.

### First Embodiment

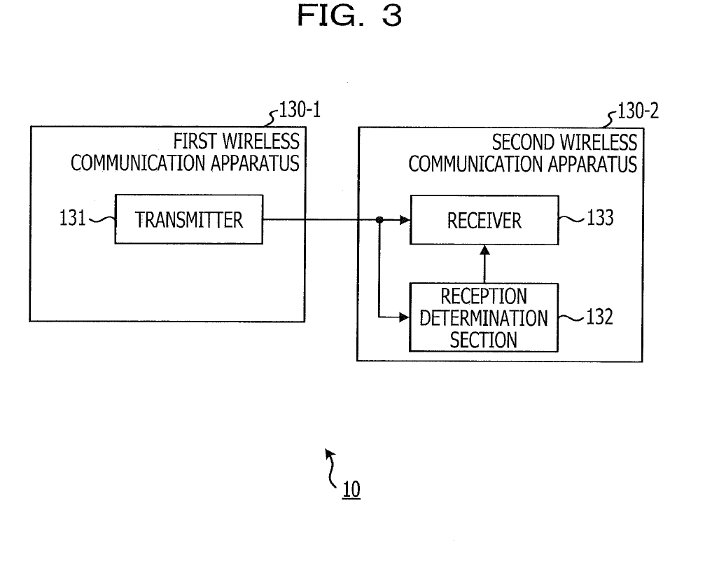

First, a first embodiment will be described. FIG. 3 is a diagram illustrating a configuration example of a wireless communication system 10 according to a first embodiment. The wireless communication system 10 includes a first wireless communication apparatus 130-1 and a second wireless communication apparatus 130-2. The first and the second wireless communication apparatuses 130-1 and 130-2 may start transmitting a wireless signal when received power of a wireless signal transmitted from another wireless communication apparatus is smaller than or equal to a carrier sense threshold value. For example, the first wireless communication apparatus 130-1 and the second wireless communication apparatus 130-2 may autonomously perform wireless communication.

The first wireless communication apparatus 130-1 includes a transmitter 131. The transmitter 131 may transmit a wireless signal.

The second wireless communication apparatus 130-2 includes a reception determination section 132 and a receiver 133. The reception determination section 132 determines whether or not to receive a data signal following a first signal based on received power of the first signal included in a wireless signal received from the first wireless communication apparatus 130-1. The receiver 133 receives or does not receive the data signal following the first signal according to the determination.

In this way, the second wireless communication apparatus 130-2 may select to receive or not to receive a data signal transmitted from the first wireless communication apparatus 130-1 based on, for example, received power of the first signal included in a wireless signal transmitted from the first wireless communication apparatus 130-1.

Therefore, even if a wireless signal that is not directed to the second wireless communication apparatus 130-2 arrives at the second wireless communication apparatus 130-2 from the first wireless communication apparatus 130-1, the second wireless communication apparatus 130-2 may select not to receive a data signal included in the wireless signal. In this case, data transmitted from another wireless communication apparatus which is other than the first wireless communication apparatus 130-1 and which communicates with the second wireless communication apparatus 130-2 is not retransmitted. Therefore, the second wireless communication apparatus 130-2 may receive the data without waiting for receiving the data from the other wireless communication apparatus for a certain time period. Hence, for example, the wireless communication system 10 does not wait for the data for a certain time period, so that data delay disappears accordingly. Thus, it is possible to reduce degradation of the network capacity of the entire wireless communication system 10.

The reception determination section 132 may also determine whether or not to receive the data signal following the first signal based on a transmission destination included in the first signal received from the first wireless communication apparatus 130-1. Also in this case, the reception determination section 132 may determine not to receive the data signal when the transmission destination is not the second wireless communication apparatus 130-2, the second wireless communication apparatus 130-2 may select not to receive the data signal transmitted from the first wireless communication apparatus 130-1. Therefore, in the same manner as in the example described above, the wireless communication system 10 may reduce degradation of the network capacity.

### Second Embodiment

### ENTIRE CONFIGURATION EXAMPLE

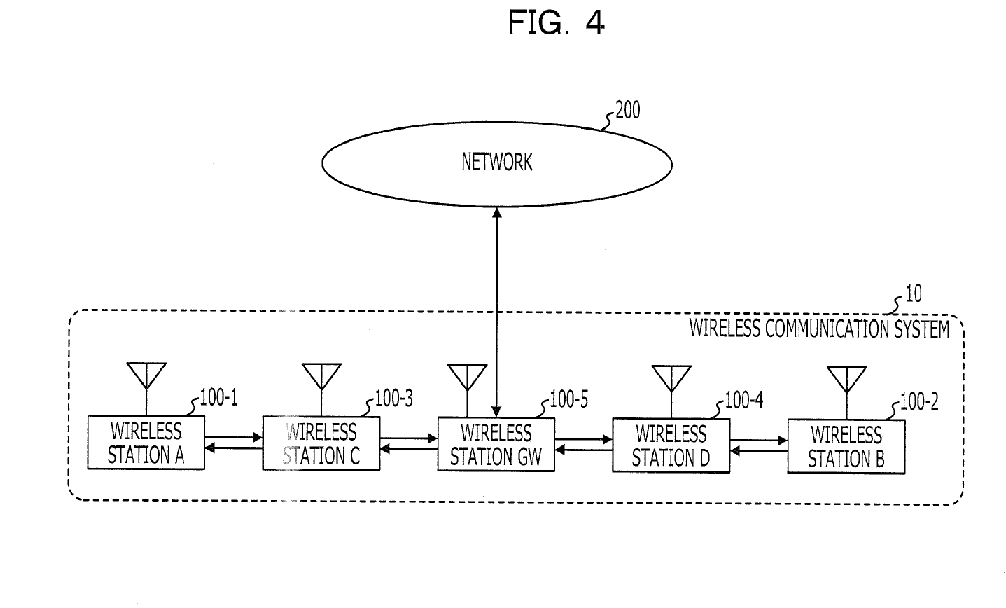

Next, a second embodiment will be described. FIG. 4 is a diagram illustrating a configuration of a wireless communication system 10 according to the second embodiment. The wireless communication system 10 is the wireless ad hoc network system described above and includes a plurality of wireless communication apparatuses (hereinafter referred to as “wireless stations”) (A) 100-1 to (GW) 100-5. The wireless ad hoc network system is, for example, a wireless communication system in which the wireless stations (A) 100-1 to (GW) 100-5 may autonomously perform wireless communication.

Although FIG. 4 illustrates an example of five wireless stations (A) 100-1 to (GW) 100-5, the number of wireless stations may be any number of two or more. Among them, the wireless station (GW) (hereinafter referred to as “gateway (GW)”) 100-5 is connected to a network 200 and, for example, the gateway (GW) 100-5 may collect data signals (hereinafter referred to as “data”) received from other wireless stations (A) 100-1 to (D) 100-4 and transmit the data to the network 200. The gateway (GW) 100-5 may also transmit data or the like transmitted from the network 200 to the other wireless stations (A) 100-1 to (D) 100-4.

For example, in the wireless communication system 10, the wireless stations (A) 100-1 to (D) 100-4 include a sensor function such as a temperature sensor and may transmit data such as a measured temperature to the gateway (GW) 100-5 via the wireless station (C) 100-3 or (D) 100-4. In this case, the gateway (GW) 100-5 may transmit collected data to another apparatus by transmitting the collected data to the network 200.

As the wireless communication system 10, the wireless stations (A) 100-1 to (D) 100-4 may be mounted on fire engines and police cars to be able to communicate with each other.

The wireless stations (A) 100-1 to (GW) 100-5 may communicate with each other. As described above, the wireless stations (A) 100-1 to (GW) 100-5 may start transmission to other wireless stations (A) 100-1 to (GW) 100-5 by performing carrier sense.

For example, the wireless stations (A) 100-1 to (GW) 100-5 may transmit a wireless signal to other wireless stations (A) 100-1 to (GW) 100-5 when received power of a reception signal received from other wireless stations (A) 100-1 to (GW) 100-5 is smaller than or equal to a carrier sense threshold value. On the other hand, the wireless stations (A) 100-1 to (GW) 100-5 do not transmit a wireless signal to other wireless stations (A) 100-1 to (GW) 100-5 when the received power is greater than the carrier sense threshold value.

In this embodiment, the wireless stations (A) 100-1 to (GW) 100-5 may transmit or receive a wireless signal by using the above-described hop quality oriented method. Therefore, the wireless stations (A) 100-1 to (GW) 100-5 establish a path by exchanging a path information packet with other wireless stations (A) 100-1 to (GW) 100-5, so that the wireless stations (A) 100-1 to (GW) 100-5 may wirelessly communicate with other adjacent wireless stations (A) 100-1 to (GW) 100-5 within a certain distance range. Thereby, for example, as illustrated in FIG. 4, the wireless station (A) 100-1 and the wireless station (C) 100-3 may directly communicate with each other without using relay of other wireless stations (hereinafter referred to as direct wireless communication) and the wireless station (C) 100-3 and the gateway (GW) 100-5 may perform the direct wireless communication. Further, the wireless station (B) 100-2 and the wireless station (D) 100-4 may perform the direct wireless communication and the wireless station (D) 100-4 and the gateway (GW) 100-5 may perform the direct wireless communication.

In this embodiment, when the wireless stations (A) 100-1 to (GW) 100-5 receive a wireless signal, the wireless stations (A) 100-1 to (GW) 100-5 determine whether or not to receive data included in the wireless signal based on a reception determination threshold value. When a received preamble signal is greater than or equal to the reception determination threshold value, the wireless stations (A) 100-1 to (GW) 100-5 receives data following the preamble signal and when the received preamble signal is smaller than the reception determination threshold value, the wireless stations (A) 100-1 to (GW) 100-5 do not receive data following the preamble signal. The details will be described later.

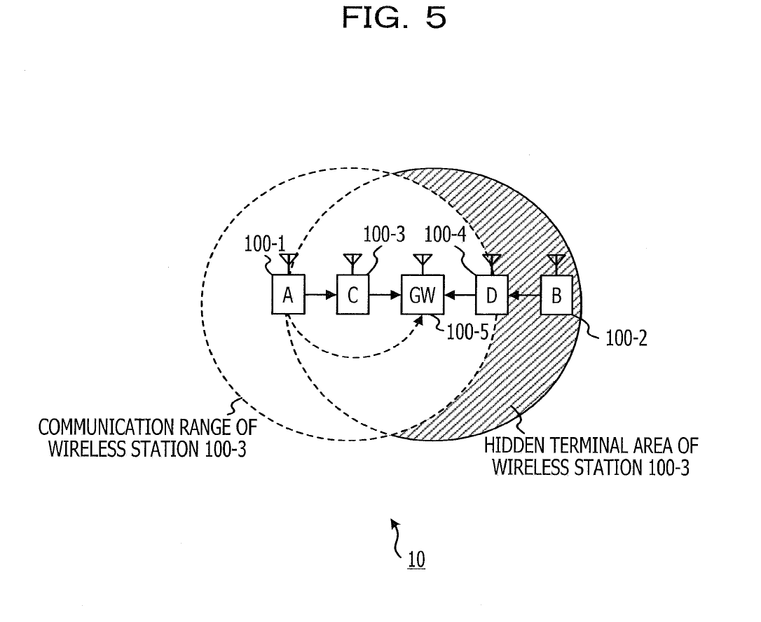

FIG. 5 illustrates a communication range of the wireless station (C) 100-3 and a communication range of the gateway (GW) 100-5 in the wireless communication system 10. Although the wireless station (B) 100-2 may communicate with the gateway (GW) 100-5 via the wireless station (D) 100-4, the wireless station (B) 100-2 is outside the communication range of the wireless station (C) 100-3. Therefore, the wireless station (B) 100-2 is a hidden terminal for the wireless station (C) 100-3.

### CONFIGURATION EXAMPLE OF WIRELESS STATION 100

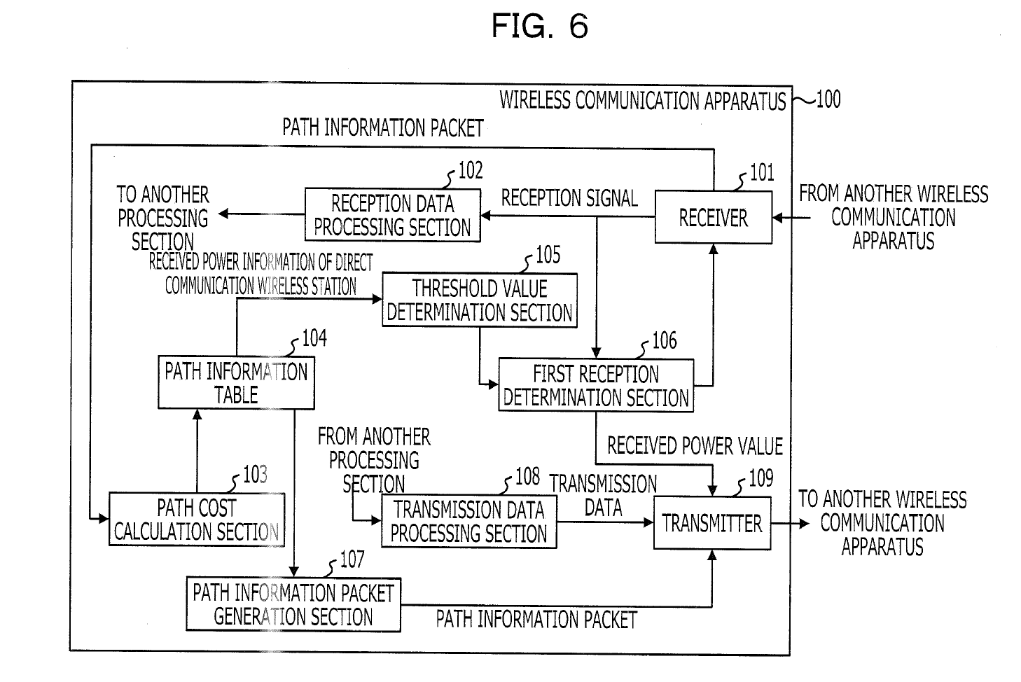

Next, a configuration example of the wireless stations (A) 100-1 to (GW) 100-5 will be described. In this embodiment, the configurations of the wireless stations (A) 100-1 to (GW) 100-5 are basically the same, so that the wireless stations (A) 100-1 to (GW) 100-5 will be described as a wireless station 100 unless otherwise stated. FIG. 6 is a diagram illustrating a configuration example of the wireless station 100.

The wireless station 100 includes a receiver 101, a reception data processing section 102, a path cost calculation section 103, a path information table 104, a threshold value determination section 105, a first reception determination section 106, a path information packet generation section 107, a transmission data processing section 108, and a transmitter 109. The gateway (GW) 100-5 may include a wired or wireless communication interface (not illustrated in the drawings) to connect to the network 20 in FIG. 4 in addition to these sections described above.

The transmitter 131 of the first embodiment corresponds to, for example, the transmitter 109. The reception determination section 132 of the first embodiment corresponds to, for example, the path information table 104, the threshold value determination section 105, and the first reception determination section 106. Further, the receiver 133 of the first embodiment corresponds to, for example, the receiver 101.

The receiver 101 may receive a wireless signal transmitted from other wireless stations (A) 100-1 to (GW) 100-5, convert (down-convert) the wireless signal into a baseband signal, and output the baseband signal as a reception signal. The receiver 101 includes an A/D (Analog/Digital) conversion circuit, a frequency convertor, a band-pass filter (BPF), and the like to perform such a conversion process.

When a path information packet signal is included in the reception signal (hereinafter referred to as “path information packet”), the receiver 101 may output the path information packet to the path cost calculation section 103. Further, the receiver 101 may output reception signals other than the path information packet to the reception data processing section 102 and the first reception determination section 106.

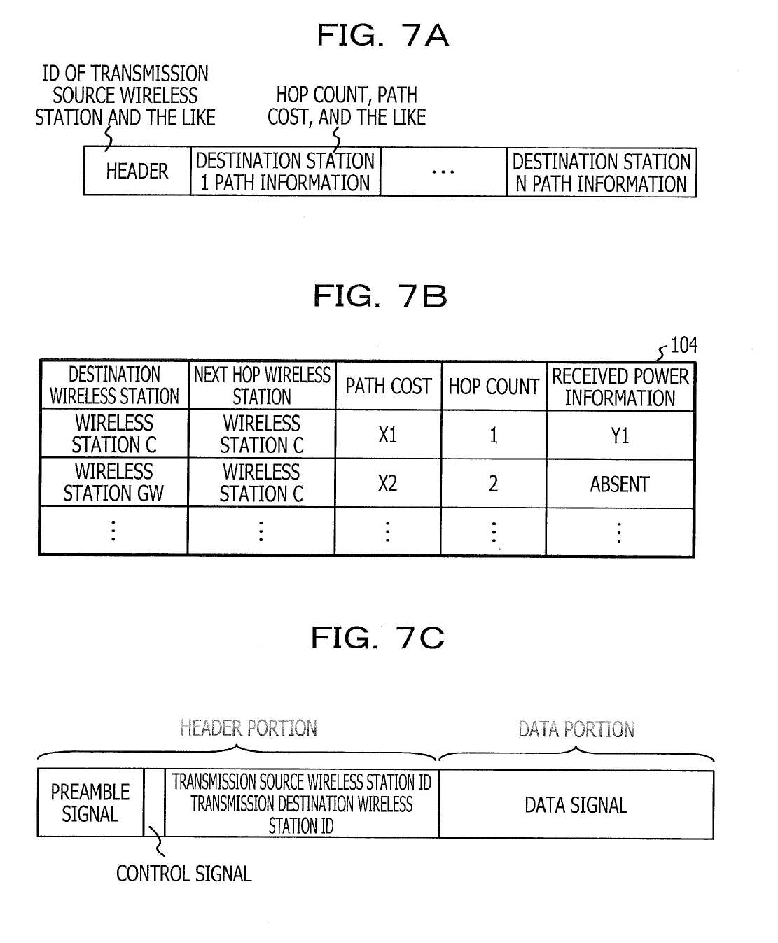

Further, a reception determination result may be inputted into the receiver 101 from the first reception determination section 106. When the reception determination result instructs the receiver 101 to receive data, the receiver 101 performs processing such as down-conversion on data following the preamble signal. On the other hand, when the reception determination result instructs the receiver 101 not to receive data, the receiver 101 does not perform processing such as down-convert on the data and, for example, may discard the data section. For example, FIG. 7C illustrates a wireless signal. Although the details will be described later, the wireless signal includes a header section and a data section. The data section is arranged in a given area in the wireless signal, so that the receiver 101 may cause the data section following the preamble signal to be inputted or not to be inputted after a certain time has passed since the reception of the preamble signal based on the reception determination result. The receiver 101 may have a memory inside thereof, once hold the wireless signal in the memory, and delete the data section from the memory or read the data section from the memory and perform processing such as down-convert on the data section based on the reception determination result.

The reception data processing section 102 performs processing such as demodulation processing and decoding processing on the data included in the wireless signal (or the reception signal). For example, the wireless signal includes a control signal including information such as a demodulation method and a coded rate. The control signal received by the receiver 101 is inputted into the reception data processing section 102 and the reception data processing section 102 may perform the demodulation processing and the decoding processing on the data based on the control signal. The reception data processing section 102 may output data on which the demodulation processing and the like are performed to other processing sections such as a monitor.

The path cost calculation section 103 may calculate a path cost of the path to the wireless station 100 based on a path cost included in the path information packet and store the path cost in the path information table 104. When a path included in the path information packet is not stored in the path information table 104, the path cost calculation section 103 may also store the path in the path information table 104. Further, the path cost calculation section 103 may also store received power information of a wireless station (hereinafter referred to as an adjacent wireless station) directly communicating with the wireless station 100, which is calculated when the path information packet is received, in the path information table 104. The details of the path information packet and a registration process to the path information table 104 by the path cost calculation section 103 will be described later.

For example, information of a path where a link is established is stored in the path information table 104. FIG. 7B illustrates the path information table 104. The path information table 104 stores a destination wireless station of a path, the next hop wireless station of the path, the path cost, the received power information (or received power value) when the destination wireless station is an adjacent wireless station, and the like. The details of the path information table 104 in FIG. 7B will be also described later.

The threshold value determination section 105 reads the received power information of the adjacent wireless station from the path information table 104 and determines a lowest received power value of the received power information as the reception determination threshold value. The threshold value determination section 105 may also determine a value lower than the lowest received power value as the reception determination threshold value, considering the possibility of further lowering the received power from the adjacent wireless station in a wireless environment where there is fading. The threshold value determination section 105 outputs the determined reception determination threshold value to the first reception determination section 106. The reason why the reception determination threshold value is set to the lowest received power value is, for example, to make it possible for the wireless station 100 to receive data transmitted from any adjacent wireless station.

The first reception determination section 106 calculates a received power value of the preamble signal included in the wireless signal and compares the calculated received power value with the reception determination threshold value. When the received power value of the preamble signal is greater than or equal to the reception determination threshold value, the first reception determination section 106 generates a reception determination result instructing to receive data following the preamble signal. On the other hand, when the received power value of the preamble signal is smaller than the reception determination threshold value, the first reception determination section 106 generates a reception determination result instructing not to receive data following the preamble signal. The first reception determination section 106 outputs the generated reception determination result to the receiver 101.

When the received power value of the preamble signal is smaller than the reception determination threshold value, for example, the first reception determination section 106 may output the received power value to the transmitter 109. The transmitter 109 compares the received power value with the carrier sense threshold value, so that the transmitter 109 may use the received power value for transmission determination for determining whether or not to transmit the data or the like depending on state determination of the carrier sense, that is, whether or not the received power value is greater than or equal to the carrier sense threshold value.

The information packet generation section 107 reads information such as the path cost stored in the path information table 104 and generates a path information packet including the information. At this time, the information packet generation section 107 generates a path information packet in which ID of the wireless station 100 is set as the transmission source wireless station. If there is no information stored in the path information table 104, the information packet generation section 107 may generate a path information packet including only information such as ID of the wireless station 100 in order to indicate that the wireless station 100 is running.

The wireless stations (A) 100-1 to (GW) 100-5 exchange such a path information packet with each other, so that a wireless communication path by the hop quality oriented method or the like is formed. For example, in FIGS. 4 and 5, when the wireless station (C) 100-3 receives a path information packet from the gateway (GW) 100-5, the wireless station (C) 100-3 may form a path to the gateway (GW) 100-5. The path information is stored in the path information table of the wireless station (C) 100-3 and the path information is included in a path information packet transmitted from the wireless station (C) 100-3. For example, when the wireless station (A) 100-1 receives a path information packet which is transmitted from the wireless station (C) 100-3 and which includes ID of the wireless station (C) 100-3 and path information to the gateway (GW) 100-5, the wireless station (A) 100-1 may form a path to the adjacent wireless station (C) 100-3 and the gateway (GW) 100-5. In FIG. 6, the path information packet generation section 107 outputs the generated path information packet to the transmitter 109.

The transmission data processing section 108 may perform processing such as encoding processing and modulation processing on transmission data transmitted to another wireless station. The transmission data processing section 108 outputs the transmission data on which such processing is performed to the transmitter 109. The transmission data may be inputted into the transmission data processing section 108 from another processing section such as a camera.

The transmitter 109 may convert (up-convert) the transmission data and the path information packet into a wireless signal and transmit the wireless signal to another wireless station. The transmitter 109 includes a D/A conversion circuit, a frequency convertor, a band-pass filter (BPF), and the like to perform such a conversion process.

When the wireless station 100 relays data transmitted from an adjacent wireless station, for example, the receiver 101 of the wireless station 100 outputs a received wireless signal to the transmitter 109 and the transmitter 109 may amplify the wireless signal and transmit the wireless signal to an adjacent wireless station. The reception data processing section 102 decodes a reception signal and outputs the reception signal to the transmission data processing section 108, the transmission data processing section 108 performs encoding processing or the like on the reception signal and outputs the reception signal to the transmitter 109, and the transmitter 109 may transmit the reception signal to an adjacent wireless station.

Next, the path information packet and the path information table 104 will be described. FIG. 7A is a diagram illustrating a path information packet. FIG. 7B is a diagram illustrating a path information table 104.

As illustrated in FIG. 7A, the path information packet includes a header and one or a plurality of pieces of destination station path information. The header includes ID of a wireless station of transmission source of the path information packet. The destination station path information includes ID of destination wireless station, a hop count, a path cost, and the like.

The hop count in FIG. 7A is a hop count in a path between the destination wireless station of the destination station path information and a wireless station 100 that transmits the path information packet. The path cost in FIG. 7A is, for example, a sum of link costs in a path between the destination wireless station of the destination station path information and a wireless station 100 that transmits the path information packet. For example, in FIG. 5, when the gateway (GW) 100-5 receives a path information packet from the wireless station (A) 100-1 via the wireless station (C) 100-3, the path cost included in the path information packet is a link cost between the wireless station (A) 100-1 and the wireless station (C) 100-3 (in this case, the hop count between the wireless station (A) 100-1 and the wireless station (C) 100-3 is one hop, so that the path cost=the link cost). The path cost calculation section 103 of the gateway (GW) 100-5 may calculate a path cost by calculating a link cost based on the received power value of the path information packet and adding the link cost to a path cost included in the path information packet. For example, in FIG. 5, when the gateway (GW) 100-5 receives a path information packet from the wireless station (A) 100-1 via the wireless station (C) 100-3, first, the path cost calculation section 103 of the gateway (GW) 100-5 obtains a link cost between the wireless station (C) 100-3 and the gateway (GW) 100-5 based on the received power value of the path information packet. Further, the path cost calculation section 103 of the gateway (GW) 100-5 adds a path cost (link cost) between the wireless station (A) 100-1 and the wireless station (C) 100-3 included in the path information packet to the obtained link cost, so that the path cost calculation section 103 may obtain a path cost between the wireless station (A) 100-1 and the gateway (GW) 100-5. The link cost is a value calculated based on a received power value in a link between wireless stations adjacent to each other. The lower the received power value, the higher the link cost, and the higher the received power value, the lower the link cost. Therefore, for example, the lower the path cost, the larger a sum of received power values of links to the destination wireless station.

As illustrated in FIG. 7B, the path information table 104 stores, for example, “destination wireless station”, “next hop wireless station”, “path cost”, “hop count”, and “received power information” for each path (destination).

The item of “destination wireless station” stores, for example, ID of the transmission source wireless station included in the header of the received path information packet and the destination wireless station included in the destination station path information of the path information packet. When the wireless station (A) 100-1 receives a path information packet including path information of the gateway (GW) 100-5 from the wireless station (C) 100-3, ID of the wireless station (C) 100-3 which is the transmission source and ID of the gateway (GW) 100-5 are stored as the “destination wireless station”.

The item of “next hop wireless station” stores ID of the transmission source wireless station included in the header of the received path information packet. When the wireless station (A) 100-1 receives a path information packet including path information of the gateway (GW) 100-5 from the wireless station (C) 100-3, the wireless station (C) 100-3 which is the transmission source is stored in each path as the “next hop wireless station”.

The item of “path cost” stores a path cost calculated by the path cost calculation section 103. The path cost calculated as described above by the path cost calculation section 103 is stored.

The item of “hop count” stores a value obtained by adding 1 to a hop count of the path information packet received by the wireless station 100. The path information packet generation section 107 may generate a path information packet including the hop count stored in the item of “hop count” and transmit the path information packet to another wireless station.

The item of “received power information” stores received power information (or received power value) calculated by the path cost calculation section 103 or the like when the path information packet is received. The received power information may be calculated by the receiver 101 and inputted into the path cost calculation section 103. Received power information of another wireless station, which is measured by an adjacent wireless station or the like, may also be obtained by exchanging a Hello packet of OSPF (Open Shortest Path First) or another path control protocol. Such a packet may be transmitted by the transmitter 109 and received by the receiver 101.

### OPERATION EXAMPLE

Next, an operation example of the wireless station 100 configured as described above will be described. In the operation example, first, a path (or link) is formed by the hop quality oriented method and a registration process to the path information table 104 is performed. Next, the reception determination threshold value is determined based on the path information table 104 and a reception determination process is performed based on the reception determination threshold value. Therefore, first, the registration process to the path information table 104 will be described and, next, the reception determination process will be described. Although these processes are performed in the wireless stations (A) 100-1 to (GW) 100-5, if it is assumed that the processes are performed in the gateway (GW) 100-5, the processes may be easily understood.

1. Registration Process

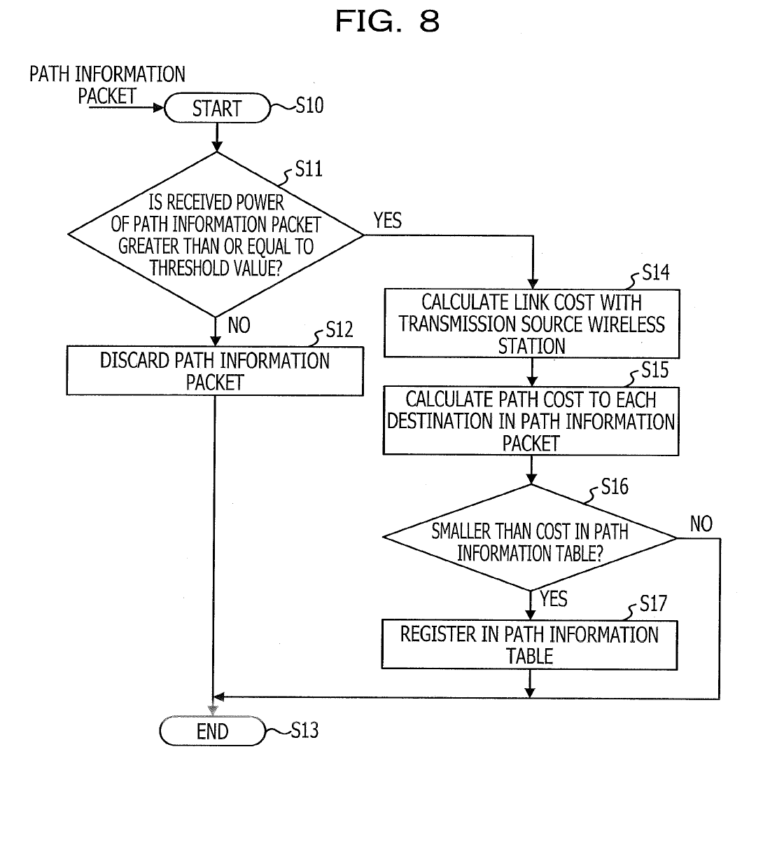

FIG. 8 is a flowchart illustrating an operation example of the registration process to the path information table 104. The registration process is performed by the path cost calculation section 103.

When the path information packet is inputted into the path cost calculation section 103 from the receiver 101, the path cost calculation section 103 starts the process (S10).

When the path information packet is inputted into the path cost calculation section 103, the path cost calculation section 103 determines whether or not the received power value of the path information packet is greater than or equal to a path information packet reception threshold value (S11). For example, in the wireless communication system 10, when a path is formed by the hop quality oriented method, wireless stations within a certain distance range establish a wireless link. Therefore, the path information packet reception threshold value may be a threshold value corresponding to a certain distance range sufficient to form such a path. The path cost calculation section 103 determines whether or not a wireless station is within the certain distance range based on the received power of the received path information packet. For example, the received power value of the path information packet may be calculated by the path cost calculation section 103 or may be calculated by the receiver 101 and inputted into the path cost calculation section 103. Further, in addition to the received power value, SIR or SINR (Signal to Interference Noise Ratio) or the like of the path information packet may be compared with the path information packet reception threshold value.

When the received power value of the path information packet is smaller than the path information packet reception threshold value (No in S11), the path cost calculation section 103 determines that a wireless link with the transmission source wireless station does not satisfy a desired quality (does not become an adjacent wireless station) and discards the path information packet (S12). The desired quality is a quality sufficient to establish multi-hop communication by the hop quality oriented method.

On the other hand, when the received power value of the path information packet is greater than or equal to the path information packet reception threshold value (Yes in S11), the path cost calculation section 103 determines that a wireless link with the transmission source wireless station of the path information packet satisfies the desired quality (becomes an adjacent wireless station) and calculates a link cost of the link (S14). For example, the path cost calculation section 103 may calculate the link cost based on the received power value of the path information packet.

Next, the path cost calculation section 103 calculates a path cost to the destination wireless station in the path information packet (S15). For example, the path cost calculation section 103 may calculate the path cost by summing up the path cost included in the path information packet and the link cost calculated in S14.

Next, the path cost calculation section 103 determines whether or not the calculated path cost is smaller than the path cost stored in the path information table 104 (S16). As described above, the lower the path cost, the larger a sum of received power values of each wireless station on the path. In other words, the path cost corresponds to the reception quality in the path. Therefore, when the calculated path cost is smaller than the path cost already stored in the path information table 104, the path where the path cost is calculated has a higher reception quality, and for example, becomes an optimal path. In this way, the path cost calculation section 103 selects a path whose path cost is smaller as the optimal path.

When the calculated path cost is smaller than the path cost stored in the path information table 104 (Yes in S16), the path cost calculation section 103 registers the calculated path cost in the path information table 104 (S17). In the path information table 104, for example, ID of the destination wireless station included in the destination station path information of the path information packet and ID of the transmission source wireless station included in the header of the path information packet are respectively stored as the “destination wireless station” and the “next hop wireless station”, and further, the path cost obtained by adding the calculated link cost to the path cost included in the destination station path information, the received power value calculated when the path information packet is received, and the like are stored.

Then, the path cost calculation section 103 completes the series of processes (S13).

On the other hand, when the calculated path cost is greater than or equal to the path cost stored in the path information table 104 (No in S16), the path stored in the path information table 104 is the optimal path, so that the path cost calculation section 103 ends the process (S13) without performing the registration process (S17).

The wireless stations (A) 100-1 to (GW) 100-5 perform registration process to the path information table 104 as described above, so that the wireless stations (A) 100-1 to (GW) 100-5 may form a path to the destination wireless station and, for example, perform wireless communication by the hop quality oriented method as illustrated in FIGS. 4 and 5. In the path information tables 104 of the wireless stations (A) 100-1 to (GW) 100-5, the received power information of an adjacent wireless station is registered. Regarding the received power information of an adjacent wireless station, for example, the received power value calculated in the process of S11 may be registered in the path information table 104 as the received power information when the registration process of S17 is performed. The wireless stations (A) 100-1 to (GW) 100-5 may perform the reception determination process.

2. Reception Determination Process

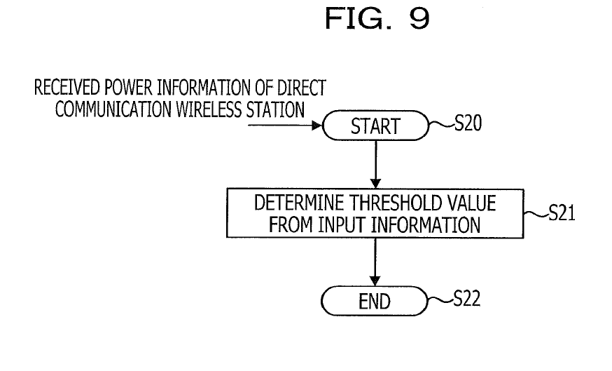

The wireless station 100 performs a process for determining the reception determination threshold value, and subsequently performs the reception determination process. First, the reception determination threshold value determination process will be described. FIG. 9 is a flowchart illustrating an operation example of the reception determination threshold value determination process. For example, this process is performed by the threshold value determination section 105.

The threshold value determination section 105 may start the process when the received power value is stored in the path information table 104 (S20). The threshold value determination section 105 may start the process by reading the received power value from the path information table 104.

When the threshold value determination section 105 starts the process, the threshold value determination section 105 determines the reception determination threshold value (S21). For example, in the path information table 104, the received power value and the like are stored for each link to an adjacent wireless station, so that the threshold value determination section 105 may read the received power values of the links and determine the smallest received power value of the read received power values as the reception determination value. As described above, the threshold value determination section 105 may determine a value obtained by subtracting a certain margin from the smallest received power value as the reception determination value.

Then, the threshold value determination section 105 completes the series of processes (S22). The threshold value determination section 105 may output the determined reception determination threshold value to the first reception determination section 106.

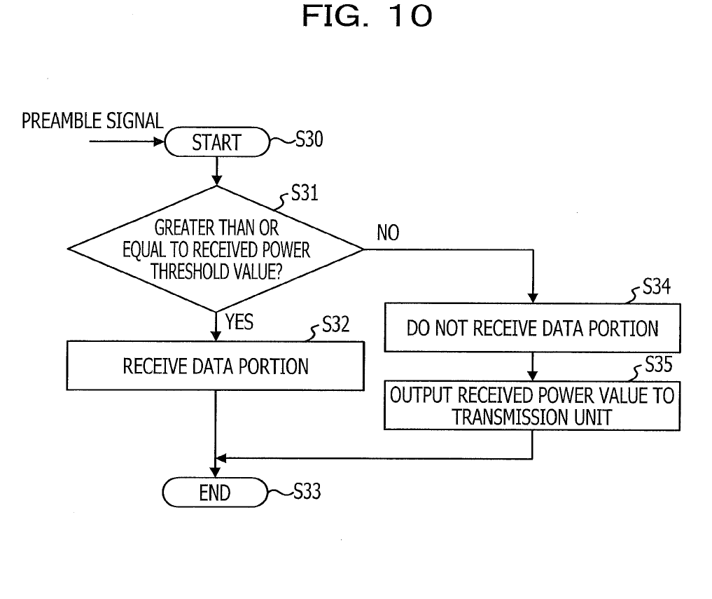

When the reception determination threshold value is determined, the wireless station 100 performs the reception determination process. FIG. 10 is a flowchart illustrating a reception determination process. For example, the reception determination process is performed by the first reception determination section 106.

When the first reception determination section 106 receives the preamble signal from the receiver 101, the first reception determination section 106 starts the process (S30). FIG. 7C is a diagram illustrating a wireless signal to be received by the receiver 101. The wireless signal includes the preamble signal, the control signal, and data. The preamble signal may be received before the data by the receiver 101. The preamble signal includes a bit pattern known between wireless stations, and is used for, for example, reception synchronization in the wireless station 100. FIG. 7C may also illustrate the reception signal outputted from the receiver 101.

When starting the process, the first reception determination section 106 measures the received power value of the preamble signal and determines whether or not the measured received power value is greater than or equal to the reception determination threshold value (S31). The reception determination threshold value is, for example, a threshold value for receiving a wireless signal transmitted from an adjacent wireless station that performs the direct wireless communication and not receiving a wireless signal transmitted from a wireless station that does not perform the direct wireless communication. For example, in FIG. 5, the gateway (GW) 100-5 may receive the wireless signal transmitted from the wireless station (A) 100-1 to the wireless station (C) 100-3 (dashed line in FIG. 5) and the wireless signal transmitted from the wireless station (C) 100-3 to the gateway (GW) 100-5. It is possible for the gateway (GW) 100-5 not to receive data of the wireless signal transmitted from the wireless station (A) 100-1 but to receive data included in the wireless signal transmitted from the wireless station (C) 100-3, which is an adjacent wireless station, by the reception determination threshold value.

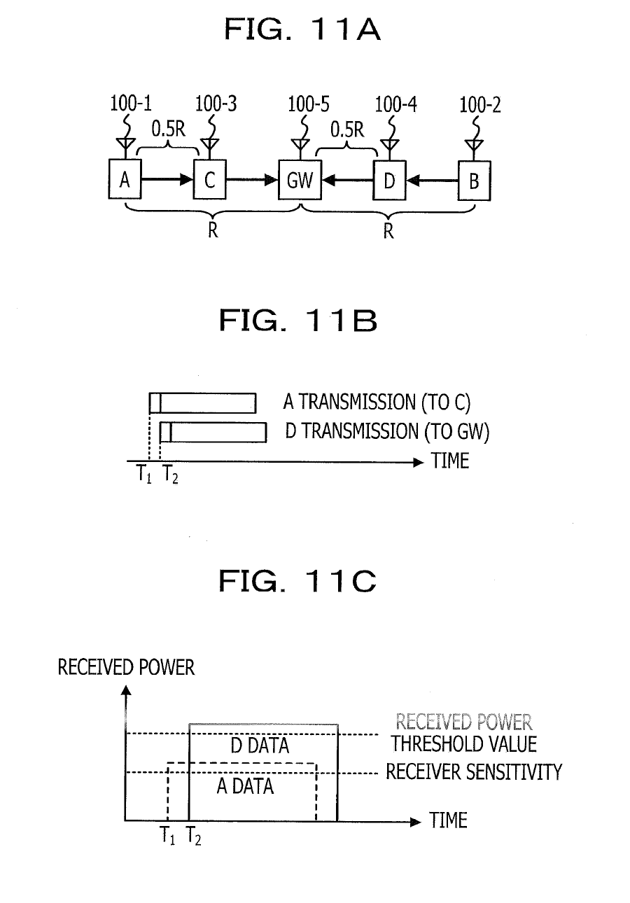

FIGS. 11A to 11C are diagrams for explaining the reception determination threshold value. In FIG. 11A, a maximum communication range of each of the wireless stations (A) 100-1 to (GW) 100-5 in the wireless communication system 10 is defined as R. In this case, when one of other wireless stations (A) 100-1 to (GW) 100-5 located in the communication range R transmits a wireless signal, the wireless stations (A) 100-1 to (GW) 100-5 may receive a corresponding preamble signal. FIG. 11A illustrates a case in which the wireless stations (A) 100-1 to (GW) 100-5 are aligned on a straight line and distances between the wireless stations are 0.5R.

In FIGS. 11A to 11C, for example, it is assumed that the wireless station (A) 100-1 transmits a wireless signal to the wireless station (C) 100-3 at time T1 and the wireless station (D) 100-4 transmits a wireless signal to the gateway (GW) 100-5 at time T2 (T2>T1). The wireless station (A) 100-1 transmits the wireless signal earlier than the wireless station (D) 100-4. In this case, the gateway (GW) 100-5 does not receive data from the wireless station (A) 100-1 because the received power of the preamble signal of the wireless signal from the wireless station (A) is smaller than the reception determination threshold value. On the other hand, the gateway (GW) 100-5 receives data from the wireless station (D) 100-4 because the received power of the preamble signal from the wireless station (D) is greater than or equal to the reception determination threshold value. In this way, by the reception determination threshold value, data from an adjacent wireless station may be received, and even when a transmission from the adjacent wireless station is later than a transmission from a wireless station other than adjacent wireless stations, data from the adjacent wireless station may be received.

In the process of S31 in FIG. 10, the first reception determination section 106 may measure SIR or SINR of the preamble signal instead of the received power value and compare the SIR or the SINR with the reception determination threshold value. The reception determination threshold value in this case is assumed to be, for example, a value determined based on SIR or SINR of the path information packet as the received power information.

When the received power of the preamble signal is greater than or equal to the reception determination threshold value (Yes in S31), the first reception determination section 106 generates a reception determination result instructing to receive data following the preamble signal and outputs the reception determination result to the receiver 101 (S32). Based on the reception determination result, the receiver 101 performs processing such as down-conversion on data following the preamble signal to receive the data. In this case, for example, the gateway (GW) 100-5 determines the wireless signal as a wireless signal from the adjacent wireless station (C) 100-3 or the like that performs the direct wireless communication with the gateway (GW) 100-5 and receives the data.

On the other hand, when the received power of the preamble signal is smaller than the reception determination threshold value (No in S31), the first reception determination section 106 generates a reception determination result instructing not to receive data following the preamble signal and outputs the reception determination result to the receiver 101 (S34). Based on the reception determination result, the receiver 101 discards the data following the preamble signal and does not to perform processing such as down-conversion on the data. In this case, for example, the gateway (GW) 100-5 determines the wireless signal as a wireless signal from the wireless station (A) 100-1 or the like that is not the adjacent wireless station (C) 100-3 that performs the direct wireless communication with the gateway (GW) 100-5 and the gateway (GW) 100-5 does not receive data included in the wireless signal.

Next, the first reception determination section 106 outputs the received power value used for the determination to the transmitter 109 (S35). For example, the received power value may be used for state determination of the carrier sense in the transmitter 109. For example, when the received power value is lower than or equal to the carrier sense threshold value, the transmitter 109 may determine that the carrier sense indicates an idle state and start transmission of a wireless signal, and when the received power value is higher than the carrier sense threshold value, the transmitter 109 may determine that the carrier sense indicates a busy state and determine not to transmit a wireless signal. The received power value may be used for the state determination of the carrier sense not only when the data is not received (S34), but also when the data is received (S32).

When the first reception determination section 106 has received the data (S32) or has outputted the received power value (S35), the first reception determination section 106 completes the series of processes (S33).

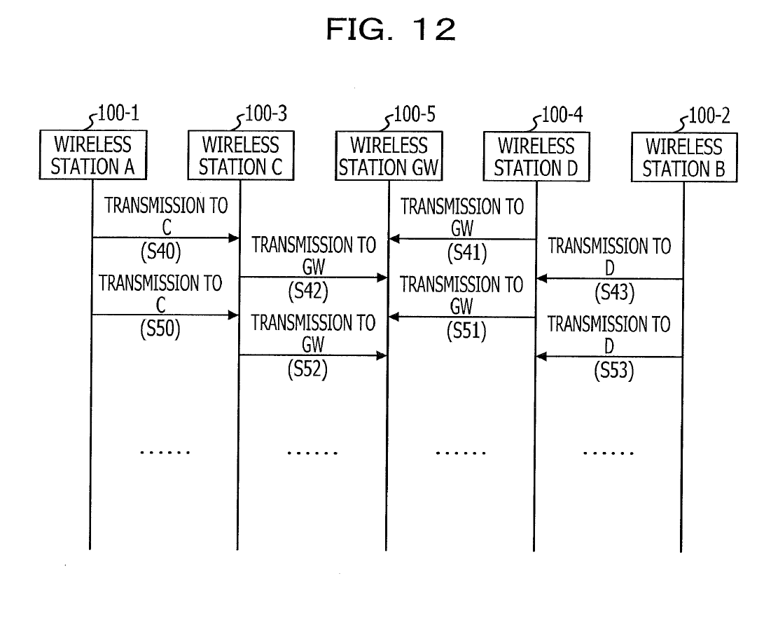

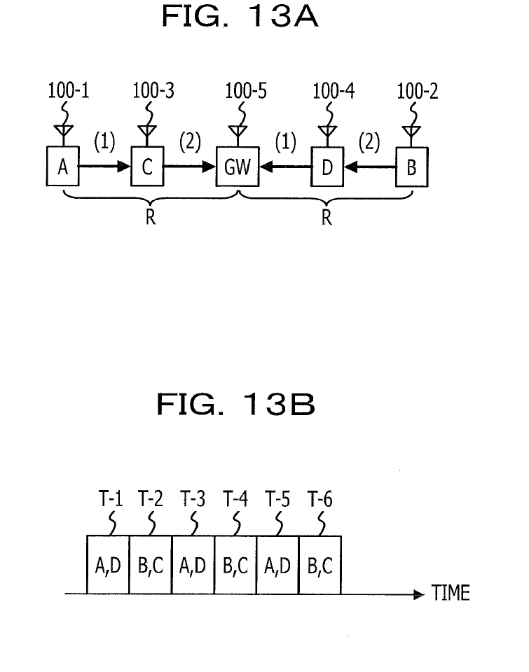

Next, an entire operation example of the wireless communication system 10 will be described with reference to FIGS. 12, 13A, and 13B. FIG. 12 is a sequence diagram illustrating the entire operation example.

When the wireless station (A) 100-1 transmits a wireless signal to the wireless station (C) 100-3 (S40), the gateway (GW) 100-5 may receive the preamble signal of the wireless signal. However, the received power value of the preamble signal is smaller than the reception determination threshold value, so that the gateway (GW) 100-5 does not receive data portion of the wireless signal transmitted from the wireless station (A) 100-1. Therefore, the gateway (GW) 100-5 may receive transmission data from the wireless station (D) 100-4 immediately after the wireless station (A) 100-1 transmits the wireless signal (S40).

On the other hand, the transmission (S40) from the wireless station (A) 100-1 to the destination wireless station (C) 100-3 is an interference source for the reception (S41) from the wireless station (D) 100-4 in the gateway (GW) 100-5. Further, the transmission (S41) from the wireless station (D) 100-4 to the gateway (GW) 100-5 is an interference source for the reception (S40) from the wireless station (A) 100-1 in the wireless station (C) 100-3.

In other words, the wireless station (C) 100-3 receives interference of the wireless signal transmitted from the wireless station (D) 100-4 and the gateway (GW) 100-5 receives interference of the wireless signal transmitted from the wireless station (A) 100-1. However, in both cases, the distance between adjacent wireless stations is shorter than the distance between the interference source and the reception wireless station, so that the SIR of the received power is higher between adjacent wireless stations. Therefore, the data transmission between adjacent wireless stations may be successfully performed.

Similarly, the wireless station (B) 100-2 may transmit a wireless signal (S43) immediately after the wireless station (C) 100-3 transmits a wireless signal (S42). Although, in this case, there is also a wireless station to be an interference source, the distance between adjacent wireless stations is shorter than the distance between the interference source and the reception wireless station, so that the data transmission between adjacent wireless stations may be successfully performed.

Thereafter, by repeating such transmission (S50 to S53), the gateway (GW) 100-5 may receive data over the entire period.

FIGS. 13A and 13B are diagrams for explaining the minimum number of transmission times in the wireless communication system 10. For example, the transmission from the wireless station (A) 100-1 and the transmission from the wireless station (D) 100-4 are started at the same time and the transmission from the wireless station (C) 100-3 and the transmission from the wireless station (B) 100-2 are started at the same time, so that the number of transmission times in the wireless communication system 10 is two, which is the minimum. For example, at the first timing, the wireless station (A) 100-1 and the wireless station (D) 100-4 transmit wireless signals to adjacent wireless stations at the same time by using the same wireless frequency. Then, at the next timing, the wireless station (B) 100-2 and the wireless station (C) 100-3 transmit wireless signals to adjacent wireless stations at the same time by using the same wireless frequency. Thereby, the number of transmission times is two, which is the minimum.

Although, the minimum number of transmission times is three in the wireless communication system by the hop quality oriented method described in FIG. 2A, the minimum number of transmission times is two in the wireless communication system 10, so that it is possible to reduce the number of transmission times. Thereby, the time period in which a wireless signal reaches the gateway (GW) 100-5 is reduced (to 2/3), so that it is possible to obtain higher communication capacity than that of FIG. 2A, and degradation of the network capacity may be reduced. Further, the wireless communication system 10 uses the hop quality oriented method, so that the area of hidden terminals is smaller than that in a system that uses the minimum hop count method (for example, FIG. 1). Therefore, it is possible to reduce the effect of the hidden terminal problem.

### Third Embodiment

Next, a third embodiment will be described. In the second embodiment, whether or not the data following the preamble signal is received is determined based on the received power value of the preamble signal. The third embodiment is an example in which the wireless station 100 receives data if a wireless signal is directed to the wireless station 100 and the wireless station 100 does not receive data if the wireless signal is not directed to the wireless station 100. Thereby, it is possible for the wireless station 100 to receive data transmitted from an adjacent wireless station and not to receive data transmitted from a wireless station other than adjacent wireless stations. The wireless communication system 10 of the third embodiment may be illustrated by, for example, FIGS. 4 and 5 in the same manner as in the second embodiment.

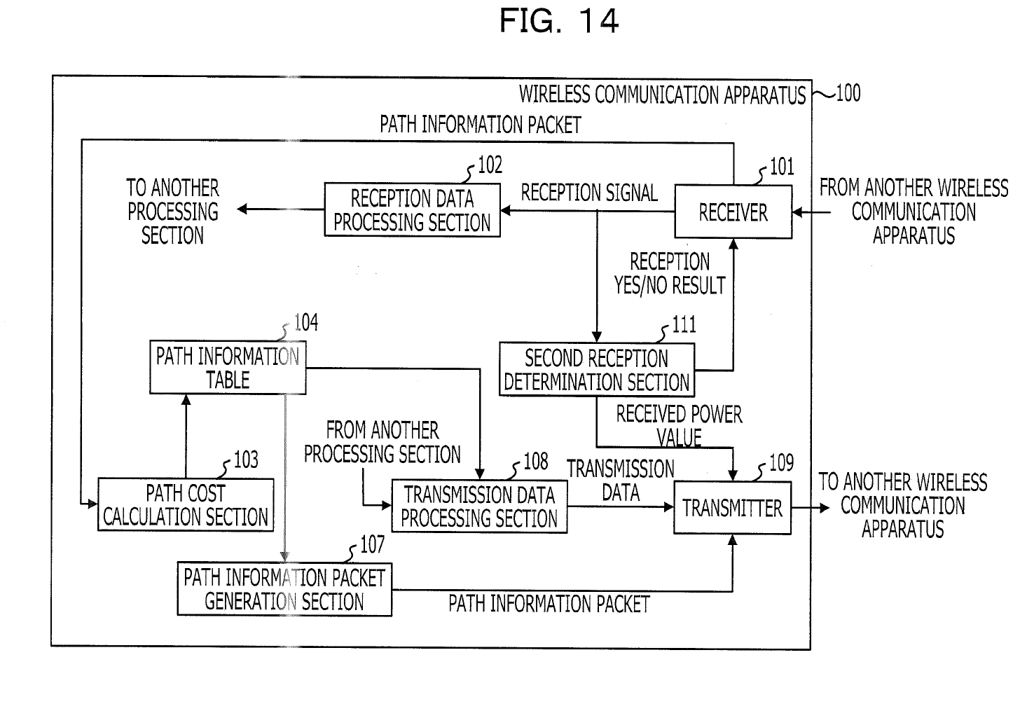

FIG. 14 is a diagram illustrating a configuration of the wireless station 100 according to the third embodiment. The wireless station 100 further includes a second reception determination section 111. The transmitter 131 of the first embodiment corresponds to, for example, the transmitter 109. The reception determination section 132 of the first embodiment corresponds to, for example, the path information table 104, the threshold value determination section 105, and the second reception determination section 111. Further, the receiver 133 of the first embodiment corresponds to, for example, the receiver 101.

When the transmission destination of a received wireless signal is ID of the wireless station 100, the second reception determination section 111 may generate a reception determination result instructing to receive a data portion following the transmission destination and output the reception determination result to the receiver 101. On the other hand, when the transmission destination is not the ID of the wireless station 100, the second reception determination section 111 may generate a reception determination result instructing not to receive the data portion following the transmission destination and output the reception determination result to the receiver 101.

In the same manner as in the second embodiment, the wireless station 100 forms a path of the hop quality oriented method (for example, FIG. 5 and the like) by the path cost calculation section 103, the path information table 104, and the path information packet generation section 107. This process may be performed by, for example, FIG. 8 in the same manner as in the second embodiment. Although ID of the transmission source wireless station is registered in the path information table 104, the ID of the transmission source wireless station is also ID of a transmission destination wireless station in an established path. Therefore, for example, the transmission data processing section 108 reads the ID of the transmission destination wireless station from the path information table 104 and generates a transmission signal using the ID as the transmission destination, and the transmitter 109 may generate a wireless signal whose header includes the ID of the transmission destination wireless station (for example, FIG. 7C).

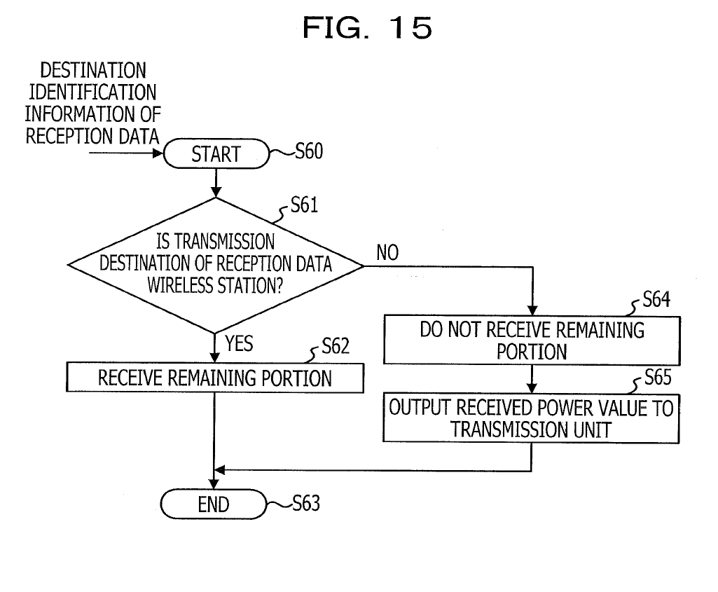

FIG. 15 is a flowchart illustrating a reception determination process according to the third embodiment. The reception determination process is performed by the second reception determination section 111.

For example, a reception signal down-converted from a wireless signal by the receiver 101 is inputted into the second reception determination section 111 and the second reception determination section 111 reads ID of the wireless station to be the transmission destination from the header of the reception signal and starts the process (S60).

Next, the second reception determination section 111 determines whether or not the read ID is ID of the wireless station 100 (S61). When the ID is ID of the wireless station 100 (Yes in S61), the second reception determination section 111 instructs the receiver 101 to receive data following the transmission destination (S62). On the other hand, when the ID is not ID of the wireless station 100 (No in S61), the second reception determination section 111 instructs the receiver 101 not to receive data following the transmission destination (S64). For example, the second reception determination section 111 may holds ID of the wireless station 100. The second reception determination section 111 may also perform the process by reading ID of the wireless station 100 stored in the path information table 104.

For example, in the wireless communication system 10 in FIG. 5, although the gateway (GW) 100-5 receives data which is transmitted from the wireless station (C) 100-3 and whose transmission destination is the gateway (GW) 100-5, the gateway (GW) 100-5 does not receive data which is transmitted from the wireless station (A) 100-1 and whose transmission destination is the wireless station (C) 100-3. Also, it is possible for the wireless station (C) 100-3 to receive data which is transmitted from the wireless station (A) 100-1 and whose transmission destination is the wireless station (C) 100-3 and not to receive data which is transmitted from the wireless station (D) 100-4 and whose transmission destination is the gateway (GW) 100-5.

In this way, the wireless station 100 receives data when the wireless signal is directed to the wireless station 100 and does not receive data when the wireless signal is not directed to the wireless station 100, so that, in the same manner as in the second embodiment, the wireless station 100 does not receive data from an interference source and degradation of the network capacity may be reduced.

In FIG. 15, the second reception determination section 111 outputs the received power value to the transmitter 109 (S65), and the second reception determination section 111 may complete the series of processes (S63). The received power value may be used for the state determination of the carrier sense in the same manner as in the second embodiment.

On the other hand, after the second reception determination section 111 instructs to receive data (S62), the second reception determination section 111 may complete the series of processes (S63).

### Other Embodiments

Next, other embodiments will be described. The wireless station 100 described in the first to the third embodiments may be realized by, for example, a configuration illustrated in FIG. 16. The wireless station 100 further includes a CPU (Central Processing Unit) 130, a ROM (Read Only Memory) 131, a RAM (Random Access Memory) 132, and a memory 133. By a cooperative operation of the CPU 130, the ROM 131, and the RAM 132, it is possible to realize the functions of the reception data processing section 102, the path cost calculation section 103, the threshold value determination section 105, the first reception determination section 106, the path information packet generation section 107, the transmission data processing section 108, and the second reception determination section 111 in the second and the third embodiments. The memory 133 stores the path information table 104 in the second embodiment.

In the second embodiment, the reception determination is performed based on the received power of the preamble signal. However, the reception determination may be performed based on received power of a signal indicating that data follows the signal, instead of the preamble signal. In a wireless signal, for example, a header portion may include a signal indicating that data is transmitted. If the signal is included, the wireless signal, in which data is inserted in a data portion following the header portion, is transmitted. For example, in FIG. 7C, the signal may be included in the area of the header portion or the control signal and transmitted. When the received power of the signal indicating that data is transmitted subsequently is greater than or equal to the reception determination threshold value, the first reception determination section 106 of the wireless stations (A) 100-1 to (GW) 100-5 generates a reception determination result indicating that data following the signal is received, and when the received power is smaller than the reception determination threshold value, the first reception determination section 106 generates a reception determination result indicating that the data is not received. Further, it is possible to use an RTS packet including a signal indicating that a data packet is subsequently transmitted for the reception determination instead of the preamble signal. Also in this case, the wireless stations (A) 100-1 to (GW) 100-5 compare the received power value of the RTS packet with the reception determination threshold value, and when the received power value of the RTS packet is greater than or equal to the reception determination threshold value, the wireless stations (A) 100-1 to (GW) 100-5 receive data following the RTS packet, and when the received power value of the RTS packet is smaller than the reception determination threshold value, the wireless stations (A) 100-1 to (GW) 100-5 do not receive data following the RTS packet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication method comprising:
measuring, at a first wireless communication apparatus, at least one reception power of at least one specific radio signal that is transmitted from at least one second wireless communication apparatus belonging to a same wireless communication network as the first wireless communication apparatus;
generating, without depending on any reception power of a radio signal that is transmitted from a third wireless communication apparatus belonging to a different wireless communication network from the first wireless communication apparatus, a threshold value of a reception power based on the measured at least one reception power; and
considering, when a reception power of a subsequent radio signal at the first wireless communication apparatus is less than the generated threshold value, the subsequent radio signal not to be detected.

2. The wireless communication method according to claim 1, wherein the wireless communication network of the first wireless communication apparatus includes a gateway apparatus, and
the different wireless communication network of the third wireless communication apparatus includes a different gateway apparatus.

3. The wireless communication method according to claim 2, wherein the first wireless communication apparatus is the gateway apparatus.

4. The wireless communication method according to claim 1, wherein each of the at least one second wireless communication apparatus is an adjacent wireless communication apparatus of the first wireless communication apparatus.

5. The wireless communication method according to claim 4, wherein the at least one second wireless communication apparatus does not include a hidden wireless communication apparatus from the first wireless communication apparatus.

6. The wireless communication method according to claim 1, wherein the first wireless communication apparatus is configured to consider, when the reception power of the subsequent radio signal at the first wireless communication apparatus is less than or equal to the generated threshold value, the subsequent radio signal not to be detected.

7. A wireless communication system comprising:
a first wireless communication apparatus; and
at least one second wireless communication apparatus belonging to a same wireless communication network as the first wireless communication apparatus, the at least one second wireless communication apparatus configured to transmit at least one specific radio signal,
wherein the first wireless communication apparatus is configured to:
measure at least one reception power of the at least one specific radio signal,
generate, without depending on any reception power of a radio signal that is transmitted from a third wireless communication apparatus belonging to a different wireless communication network from the first wireless communication apparatus, a threshold value of a reception power based on the measured at least one reception power; and
consider, when a reception power of a subsequent radio signal at the first wireless communication apparatus is less than the generated threshold value, the subsequent radio signal not to be detected.

8. A wireless communication apparatus comprising:
a memory; and
a processor coupled to the memory and configured to:
measure at least one reception power of at least one specific radio signal that is transmitted from at least one other wireless communication apparatus belonging to a same wireless communication network as the wireless communication apparatus,
generate, without depending on any reception power of a radio signal that is transmitted from a different wireless communication apparatus belonging to a different wireless communication network from the wireless communication apparatus, a threshold value of a reception power based on the measured at least one reception power, and
consider, when a reception power of a subsequent radio signal at the wireless communication apparatus is less than the generated threshold value, the subsequent radio signal not to be detected.

9. The wireless communication apparatus according to claim 8, wherein the wireless communication network of the wireless communication apparatus includes a gateway apparatus, and
the different wireless communication network of the different wireless communication apparatus includes a different gateway apparatus.

10. The wireless communication apparatus according to claim 9, wherein the wireless communication apparatus is the gateway apparatus.

11. The wireless communication apparatus according to claim 8, wherein each of the at least one other wireless communication apparatus is an adjacent wireless communication apparatus of the wireless communication apparatus.

12. The wireless communication apparatus according to claim 11, wherein the at least one other wireless communication apparatus does not include a hidden wireless communication apparatus from the wireless communication apparatus.

13. The wireless communication apparatus according to claim 8, wherein the wireless communication apparatus is configured to consider, when the reception power of the subsequent radio signal at the wireless communication apparatus is less than or equal to the generated threshold value, the subsequent radio signal not to be detected.
